(19) United States
(12) Patent Application Publication
(10) Pub. No.: US 2025/0067304 A1
(43) Pub. Date: Feb. 27, 2025

(54) LINEAR GUIDE UNIT WITH A MOVEMENT UNIT

(71) Applicant: Festo SE & Co. KG, Esslingen (DE)

(72) Inventors: Thomas WINKLER, Sulzbach (DE); Tobias HÜBSCH, Deizisau (DE); Bernd REIN, Bad Ditzenbach (DE); Peter BUK, Stuttgart (DE); Alexander MAISCHBERGER, Ostfildern-Nellingen (DE); Johannes EISWIRTH, Esslingen (DE)

(21) Appl. No.: 18/812,513

(22) Filed: Aug. 22, 2024

(30) Foreign Application Priority Data
Aug. 23, 2023 (DE) 102023122567.7

(51) Int. Cl. F16C 29/00

(52) U.S. Cl. CPC F16C 29/005; F16C 29/004

(57) ABSTRACT

A linear guide unit with a profiled body, the profiled body having a base plate with an upper side and a bottom side, and a movement unit which has a carriage and which has a guiding unit with a first guiding module located on the carriage and a second guiding module. The movement unit is mounted on the profiled body so as to be linearly movable in the longitudinal direction. A first mounting extension and a second mounting extension project from the bottom side, in which a first support surface of the first mounting extension and a second support surface of the second mounting extension project from the bottom side in a direction opposite to a vertical direction, a first clamping surface being provided on the first mounting extension and a second clamping surface being provided on the second mounting extension.

This application claims priority to German Patent Application No. 102023122567.7 filed Aug. 23, 2023, which is incorporated by reference.

The invention relates to a linear guide unit with a profiled body, wherein the profiled body has a base plate with a longitudinal direction, a transverse direction perpendicular thereto and a vertical direction orthogonal to the longitudinal direction and the transverse direction, wherein a first leg and a second leg project from an upper side of the base plate in the vertical direction and are spaced apart from one another in the transverse direction, wherein the profiled body has a first inner side and a first outer side and a second inner side and a second outer side, wherein the first inner side and the second inner side face each other, wherein a first guiding surface is provided on the first inner side and a second guiding surface is provided on the second inner side, and wherein the base plate has a bottom side opposite the upper side, and with a movement unit comprising a carriage which has a guiding unit with a first guiding module arranged on the carriage and a second guiding module arranged opposite the first guiding module at a distance in the transverse direction on the carriage, wherein the movement unit is mounted on the profiled body so as to be linearly movable in the longitudinal direction, in that the first guiding module abutting movably against the first guiding surface and the second guiding module abutting movably against the second guiding surface.

For the purposes of the present application, the longitudinal direction, which may also be referred to as the z-direction, the transverse direction, which may also be referred to as the y-direction, and the vertical direction, which may also be referred to as the x-direction, define a Cartesian coordinate system to which reference is made below, unless expressly stated otherwise.

A linear guide unit known from DE 10 2020 204 569 A1 has a movement unit which is mounted for linear movement on two mutually facing first and second guiding surfaces of a profiled body. For the mounting, the movement unit can have two guiding units located on a carriage, a guiding module and a second guiding module located opposite the first guiding module in a transverse direction, wherein the second guiding module is an adjustable guiding module, the relative position of which relative to the carriage in the transverse direction can be variably adjusted by executing an adjusting movement. The two first guiding modules are pressed against the first guiding surface and the two adjustable second guiding modules are pressed against the second guiding surface of the profiled body. Each guiding unit has its own adjustment unit, which makes it possible to apply an adjustment force to the adjustable guiding module in order to set a preload with which the two guiding modules of the relevant guiding unit are pressed against the respective guiding surface of the profiled body assigned to them. The set preload has a decisive effect on the precision with which the movement unit is guided on the profiled body. In this way, the linear guide units enable, for example, precise guidance of a machine element mounted on the carriage of the movement unit along the longitudinal direction.

In general, such linear guide units are fixed to a support, for example a flat machine table. For this purpose, clamping means connected or connectable to the support are regularly used, which apply clamping forces to the profiled body at least in sections and thus clamp it to the support. In most cases, application points for these clamping forces are provided in outer regions of the profiled body, which are spaced apart in the transverse direction so as not to impede the linear movement of the movement unit. The clamping forces cause tension or deformation of the profiled body, resulting in a change of the distance between the first guiding surface and the second guiding surface compared to a tension-free or deformation-free state.

### SUMMARY OF INVENTION

Based on this, the invention is based on the problem of ensuring the function of guiding in the fixed state.

To solve this problem, it is provided according to the invention, in conjunction with the features mentioned above, that a first and a second mounting extension project from the bottom side and are spaced apart from one another in the transverse direction, wherein a first support surface of the first mounting extension and a second support surface of the second mounting extension lie in a common plane and project from the bottom side in the opposite direction to the vertical direction, wherein a first clamping surface opposite the first support surface is provided on the first mounting extension and a second clamping surface opposite the second support surface is provided on the second mounting extension, and wherein the first support surface completely overlaps the first clamping surface and the second support surface completely overlaps the second clamping surface in the transverse direction.

In this way, it is advantageously possible to clamp the profiled body of the linear guide unit onto a support without causing any deformation in the profiled body that would impair the precision of the guiding. This is achieved by the first clamping surface being completely covered by the first support surface and the second clamping surface being completely covered by the second support surface. This favors a distribution of forces in which the clamping forces acting on the first clamping surface or the second clamping surface are dissipated directly into the support surface, in particular a machine table, via the opposing first support surface or second support surface. This leads to an advantageous stress or deformation curve in the profiled body, in which the deformation of the base plate and/or the first leg and/or the second leg can be reduced to a level that does not impair the function of the guiding. This can also be referred to as stress.

For the purposes of the present application, complete overlap in the transverse direction is understood to mean that the clamping surface or the surface resulting from a projection of the clamping surface into the plane of the support surface does not have a greater extent in the transverse direction than the support surface and thus does not project beyond the support surface in the transverse direction. Accordingly, the support surface and the clamping surface or at least the projection of the clamping surface are geometrically similar in such a way that the surfaces can be transferred into one another by means of a pure displacement in the vertical direction.

In other words, the extension of the support surface in the transverse direction always corresponds at least to the extension of the clamping surface or the projection of the clamping surface in the plane of the support surface, whereby the two surfaces are located on the corresponding mounting extension in such a way that, when projected in the vertical direction, all points of the clamping surface lie in the support surface.

Advantageous further embodiments of the invention are shown in the dependent claims.

In a further embodiment of the linear guide unit, the extent of the first support surface in the transverse direction corresponds to 0.5 to 1.25 times the extent in the transverse direction of the first clamping surface and/or the second support surface in the transverse direction corresponds to 0.5 to 1.25 times the extent in the transverse direction of the second clamping surface. This embodiment of the first support surface and the second support surface ensures that the surfaces have a compact extent in the transverse direction. Furthermore, this ensures that the distribution of forces resulting from the clamping force introduced onto the clamping surface is transferred directly to the support surface in as concentrated a manner as possible and can be diverted from there, for example, into a machine table on which the profiled body is clamped. In addition, the at least extensive surface equality between the clamping surface and the support surface allows the defined spatial alignment of these surfaces to each other and, for example, a flatness of the support surface to be produced with high accuracy, which favors an advantageous stress or deformation curve in the profiled body.

Preferably, the extent of the first support surface in the transverse direction corresponds to the extent of the first clamping surface and the extent of the second support surface in the transverse direction corresponds to the extent of the second clamping surface. This results in an essentially centric or linear distribution of forces between the clamping surface and the support surface.

In a particularly preferred embodiment, the first clamping surface is oriented parallel to the first support surface and the second clamping surface is oriented parallel to the second support surface.

The ratio of the extent of the first support surface in the transverse direction to the extent of the base plate in the transverse direction and the ratio of the extent of the second support surface in the transverse direction to the extent of the base plate in the transverse direction is expediently at most 0.1. In particular, this embodiment enables the flow of force to be guided directly to the support surface without any impermissible deformation occurring in the profiled body that would impair the function of the guide.

Expediently, the first mounting extension is located in a first outer region of the base plate and the second mounting extension is located in a second outer region of the base plate.

This arrangement achieves maximum spacing in the transverse direction between the first mounting extension and the second mounting extension as well as maximum spacing of the first clamping surface and the second clamping surface in the transverse direction to the profiled body, which improves the distribution of forces in terms of low deformation.

In a further embodiment, an upper ridge and a lower ridge are formed by a recess formed in the profiled body between the upper side and the bottom side, which extends in longitudinal direction through the entire base plate, which leads to a further improvement in rigidity and thus to less deformation of the profiled body during intended use.

Preferably, a ratio of a first distance of a central plane of the upper ridge to the first support surface or to the second support surface to a second distance of the central plane of the upper ridge to a first upper side of the first leg and/or to a second upper side of the second leg corresponds to the ratio of the second distance to the sum of the first and second distances. In other words, the first distance corresponds to approximately 38.2% of a total extension, i.e., the sum of the first and second distances. In such an arrangement, the central plane lies in the so-called golden ratio, which results in a particularly favorable distribution of stress and/or deformation.

Advantageously, a distance between a first base plate end face opposite the first clamping surface decreases with increasing distance from the first outer side of the profiled body and a distance between a second base plate end face opposite the second clamping surface decreases with increasing distance from the second outer side of the profiled body. Purely by way of example, the clamping surface is designed as the first side surface of a groove formed in the outer side and the base plate end face is designed as the second side surface of the groove and are connected in particular by a groove base surface aligned parallel to the outer side, which can also be referred to as a connecting surface. Preferably, the clamping surface is oriented transversely to the outer side while the base plate end face is oriented at an angle deviating from 90° relative to the outer side. Accordingly, the first base plate end face is aligned at a first angle to the first clamping surface and the second base plate end face is aligned at a second angle to the second clamping surface. This geometry avoids a concentration of stress in the direction of the first and second leg, in particular in a transition region from the respective connecting surface to the respective base plate end face. Accordingly, the first leg and the second leg can be further decoupled from the first mounting extension and the second mounting extension in terms of stress.

An embodiment in which a first guiding step adjacent to the first clamping surface is provided on the first mounting extension and a second guiding step adjacent to the second clamping surface is provided on the second mounting extension is considered to be particularly advantageous, with the first guiding step and the second guiding step projecting in vertical direction and serving to guide and secure any clamping elements. This guiding step is preferably directly adjacent to the respective outer side and forms an undercut in the transverse direction with respect to the first clamping surface and the second clamping surface. For example, the clamping elements can be designed in sections corresponding to the geometry of the first mounting extension and the second mounting extension. In particular, the clamping elements can have a guide groove in which the guiding step engages in the mounted state. This prevents the clamping elements from slipping in the transverse direction.

Preferably, an outer side of the first mounting extension is oriented parallel to the first outer side of the profiled body and an outer side of the second mounting extension is oriented parallel to the second outer side of the profiled body, with the outer side of the first mounting extension and the first outer side of the profiled body as well as the outer side of the second mounting extension and the second outer side of the profiled body lying in a common plane.

Advantageously, the first guiding surface is formed on a first guide rail and the second guiding surface is formed on a second guide rail, with the first guide rail being force-locked and/or material-locked connected to the first inner side and the second guide rail being force-locked and/or material-locked connected to the second inner side. The first guide rail and the second guide rail can be designed as separate components and manufactured from a material that differs from the material of the profiled body, which is advantageously a rolling bearing material, for example chrome steel.

### BRIEF DESCRIPTION OF DRAWINGS

In the following, the invention is explained in more detail with reference to the enclosed drawing, in which it is shown

FIG. 1 a preferred embodiment of the linear guide unit according to the invention in a perspective view with a movement unit mounted on a profiled body for linear movement and a force transmission unit,

FIG. 2 a perspective view of the profiled body and the movement unit from FIG. 1,

FIG. 3 a front view of the linear guide unit from FIG. 1,

FIG. 4 a front view of a preferred embodiment of the profiled body,

FIG. 5 a detailed front view of a first embodiment of a first mounting extension projecting from a bottom side of the profiled body,

FIG. 6 a detailed view of a further embodiment of a first mounting extension projecting from a bottom side of a profiled body with a projecting first guiding step in a front view, and

FIG. 7 a front view of another preferred embodiment of the profiled body.

### DETAILED DESCRIPTION OF INVENTION

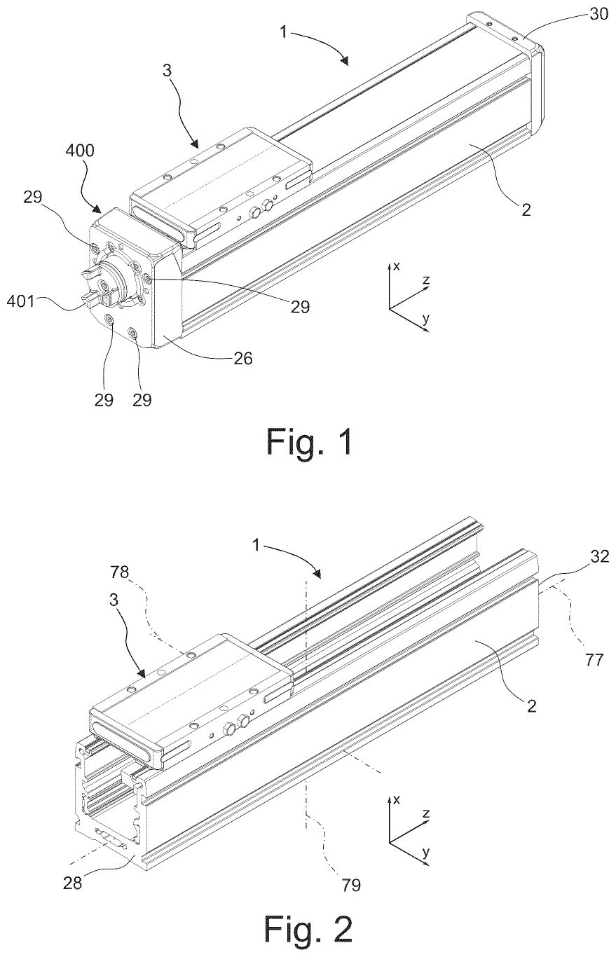

FIG. 1 shows a first version of a linear guide unit 1 with a profiled body 2, with a movement unit 3 and with a force transmission unit 400.

As can be seen from the illustration in FIG. 2, the profiled body 2 is formed in one piece, purely by way of example as an extruded aluminum part. The profiled body 2 extends with a constant profiling in a longitudinal direction 77, a transverse direction 78 perpendicular thereto and a vertical direction 79 orthogonal to the longitudinal direction 77 and transverse direction 78.

In the embodiment example shown in FIG. 1, the transmission unit 400 comprises a first bearing cover 26, which is located on a first end face 28 of the profiled body 2, a second bearing cover 30, which is located on a second end face 32 of the profiled body 2, and a transmission element rotatably mounted in the first bearing cover 26 and in the second bearing cover 30, which in the present exemplary embodiment is designed as a threaded spindle, which extends in sections through the receiving space 12. The first bearing cover 26 and the second bearing cover 30 are attached to the first end face 28 and to the second end face 32 by means of retaining means 29 engaging in mounting recesses 27, which in the present embodiment are designed as self-tapping screws.

A coupling element 401, which can be coupled to a drive for transmitting a rotational movement provided by the drive to the transmission element, is located on a section of the transmission element which is mounted in the first bearing cover 26 and which projects partly in a direction opposite to the longitudinal direction 77 with respect to the first bearing cover 26.

To convert the rotational movement provided by the drive into a linear movement of the movement unit 3, a movement-receiving element 36, which is designed as a spindle nut in the present case, is located in a receptacle 34 formed in the carriage 17.

Functionally, the profiled body 2 can be subdivided into a base plate 4, a first leg 6 and a second leg 7, which in practice are formed integrally with one another. The first leg 6 and the second leg 7 are spaced apart from one another in the transverse direction 78 and project in the vertical direction 79 from an upper side 5 of the substantially cuboid base plate 4. This forms a substantially U-shaped cross-section, which is constant over the entire extent of the profiled body 2 in longitudinal direction 77. The profiled body 2 has a first outer side 8 and a first inner side 9 as well as a second outer side 10 and a second inner side 11, with the first inner side 9 and the second inner side 11 facing each other.

In the embodiment shown, the profiled body 2 is made of aluminum and is essentially manufactured by means of aluminum extrusion.

As a result of the arrangement and orientation described above, a channel-shaped receiving space 12 is formed by the upper side 5, the first inner side 9 and the second inner side 11, which extends in longitudinal direction 77 over the entire extent of the profiled body 2. In the assembled state shown, the movement unit 3 and the force transmission unit 400 are accommodated partly in the receiving space 12, so that the movement unit 3 is linearly displaceable along the longitudinal direction 77 in the receiving space. At an end 13 of the first leg 6 facing away from the upper side 5 and at an end 14 of the second leg 7 facing away from the upper side 5, overhangs 15, 16 are formed in each case, which delimit the receiving space 12 in sections in the vertical direction 79.

In the exemplary embodiment shown, the first leg 6 and the second leg 7 are congruent, although other embodiments are also conceivable that do not impair the function of the linear guide unit 1.

The movement unit 3 has a carriage 17 and has a guiding unit 18 with a first guiding module 19 located on the carriage 17 and a second guiding module 20 located opposite to the first guiding module 19 at a distance in the transverse direction 78 and is arranged on the carriage 17. The carriage 17 is designed in such a way that it has a vertical recess 24 on a first carriage outer side 22 and a vertical recess 25 on a second carriage outer side 23, which in the assembled state correspond in the vertical direction 79 with the overhangs 15, 16, so that in this state a displacement of the movement unit 3 in the vertical direction 79 is essentially prevented.

In the embodiment shown, the first guiding module 20 and the second guiding module 21 are designed as recirculating ball bearing guiding modules, each of which has a plurality of rolling bearing elements arranged in a row and accommodated in two channels lying one above the other in vertical direction 79. The plurality of rolling bearing elements arranged in a row can also be referred to as a row of rolling elements. In the present case, the rolling bearing elements are designed as balls, but may have other suitable geometries in other embodiments. It is also conceivable that the first guiding module 20 and the second guiding module 21 are designed as different types of rolling guiding modules or as sliding guiding modules.

For precise guidance of the linear movement of the movement unit 3 along the longitudinal direction 77, a first guiding surface 38 is provided on the first inner side 9 and a second guiding surface 39 is provided on the second inner side 11, so that the movement unit 3 can be mounted on the profiled body 2 so that it can move linearly in the longitudinal direction 77. As an example, it is provided that the rows of rolling elements of the first guiding module 20, which are not shown in more detail, abut movably against the first guiding surface 38 and that the rows of rolling elements of the second guiding module 21, which are not shown in more detail, abut movably against the second guiding surface 39. During the linear movement, the rolling elements of the first guiding module 20 run along the first guiding surface 38 and the rolling elements of the second guiding module 21 run along the second guiding surface 39, whereby the contact provides a backlash-free support with respect to the profiled body 2 in all spatial directions away from the longitudinal direction 77, so that an exact linear movement of the movement unit 3 is made possible. As an example, the first guiding surface 38 and the second guiding surface 39 are a composite of surfaces with different orientations.

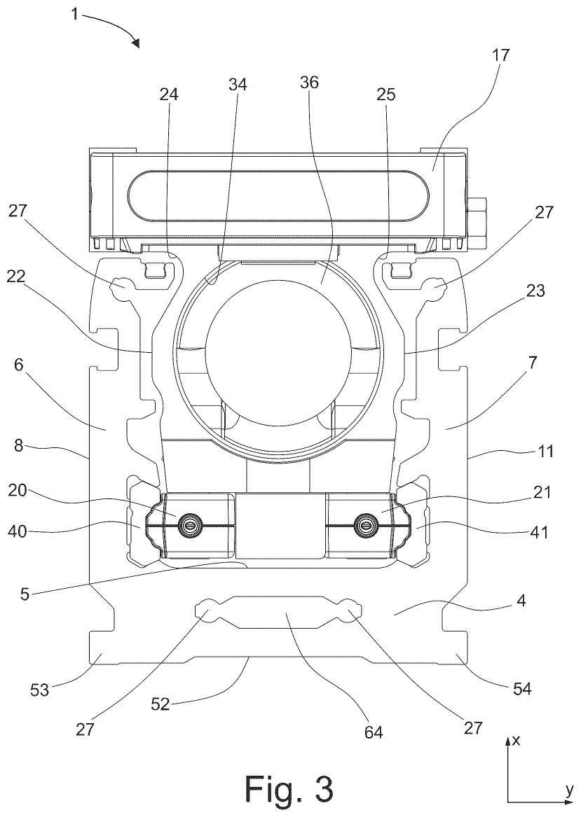

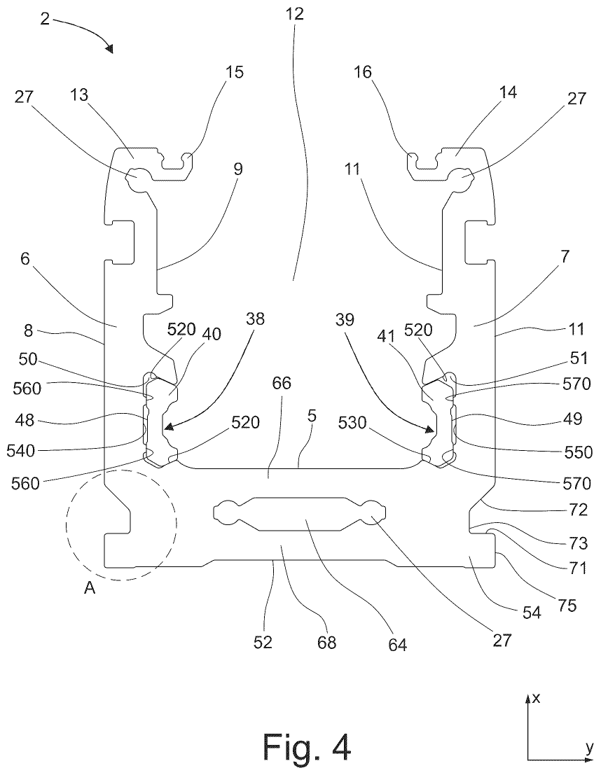

As can be seen in FIGS. 3 and 4, the first guiding surface 38 is formed on a first guide rail 40 and the second guiding surface 39 is formed on a second guide rail 41, which are designed as separate components in the embodiment shown.

The first guide rail 40 and the second guide rail 41 are designed in the present case as profiles extending in longitudinal direction 77 with a constant cross-section and furthermore each have a rear side 42, 43 and in each case two boundary surfaces 44, 45 adjoining the first guiding surface 38 and the second guiding surface 39 respectively, which bound the first guiding surface 38 and the second guiding surface 39 respectively in vertical direction 79. Furthermore, contact surfaces 46, 47 are formed on the first guide rail 40 and on the second guide rail 41 opposite the respective boundary surfaces 44, 45, and a rear surface 48, 49 is formed on each of the rear sides 42, 43, which are each prepared for contact with a corresponding surface of the profiled body 2.

The first guide rail 40 is received in a first receiving groove 50 in the first inner side 9 and the second guide rail 40 is received in a second receiving groove 51 in the second inner side 11, wherein the first receiving groove 50 and the second receiving groove 51 are each formed in a region adjacent to the upper side 5. The first receiving groove 50 and the second receiving groove 51 are each trapezoidal in shape in such a way that a distance between the respective groove side surfaces 520, 530 increases with an increasing groove depth. Two contact surfaces 560, 570 are provided on the respective groove base 540, 550, spaced apart in the vertical direction 79, which protrude with respect to the groove base 540, 550 and are prepared for contact with the respective rear surface 48, 49 of the first guide rail 40 or the second guide rail 41. In the embodiment shown in FIGS. 3 and 4, the dimensions of the first guide rail 40 and the second guide rail 41 as well as the first receiving groove 50 and the second receiving groove 51 are selected such that there is a force-locked connection in each case. In alternative embodiments, however, a force-locked and/or material-locked connection or a material-locked connection is also possible.

As shown in FIGS. 1 to 4, a first mounting extension 53 and a second mounting extension 54 project from a bottom side 52 of the base plate 4 opposite the upper side 5 and are spaced apart from one another in the transverse direction 78, a first support surface 56 of the first mounting extension 53 and a second support surface 57 of the second mounting extension 54 lying in a common plane and projecting from the bottom side 52 in the opposite direction to the vertical direction 79.

In the present case, the first mounting extension 53 and the second mounting extension 54 extend in longitudinal direction 77 over the entire extent of the base plate 4.

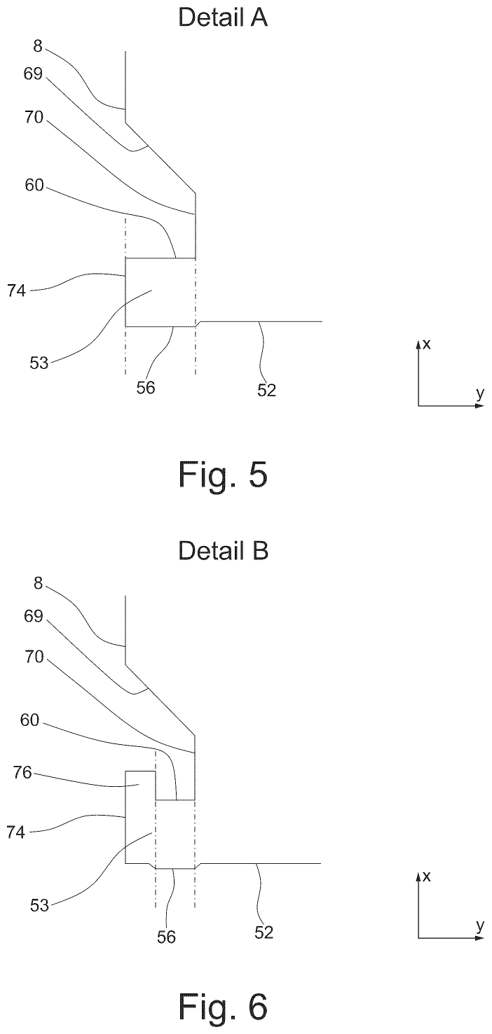

As can be seen particularly well in the detailed view A of the first mounting extension 53 shown in FIG. 5, a first clamping surface 60 opposite the first support surface 56 is provided on the first mounting extension 53. In this case, the first support surface 56 and the first clamping surface 60 are designed or located such that the first support surface 56 completely overlaps the first clamping surface 60 in the transverse direction 78. In the exemplary embodiment shown, the first clamping surface 60 is exemplarily oriented parallel to the first support surface 56. Similarly, a second clamping surface 61 opposite the second support surface 57 is provided on the second mounting extension 54, which in turn is completely overlapped by the second support surface 57 in the transverse direction 78 and, in the embodiment example, is oriented parallel thereto.

In alternative embodiments, it is possible that the first clamping surface 60 and the second clamping surface 61 are not oriented parallel to the first support surface 56 and the second support surface 57, respectively. In such cases, one speaks of a complete overlap if the area of the first clamping surface 60 or the second clamping surface 61 projected into the plane of the first support surface 56 or the second support surface 57 is overlapped completely.

The complete overlapping of the first clamping surface 60 by the first support surface 56 and the complete overlapping of the second clamping surface 61 by the second support surface 57 has the effect that a clamping force acting on the first clamping surface 60 or the second clamping surface 61, which is exerted by a clamping means not shown and acts essentially normal to the respective clamping surface 60, 61, can be dissipated via the opposite first support surface 56 or second support surface 57 into a support surface not shown, in particular a machine table. This leads to an advantageous stress distribution in the profiled body 2, in which a deformation of the base plate 4 and/or the first leg 6 and/or the second leg 7 can be reduced to a degree that does not impair the function of guiding. In particular, a change in distance between the first guiding surface 38 and the second guiding surface 39 in the transverse direction or a tilting of the surfaces caused or capable of being caused by the deformation is to be prevented. In this context, it is also possible to speak of a stress decoupling of the first mounting extension 53 and second mounting extension 54 from the base plate 4 and/or from the first leg 6 and/or from the second leg 7.

This effect is given in particular if, as shown in FIGS. 5 and 6, an extent of the first support surface 56 in transverse direction 78 corresponds to the extent of the first clamping surface 60 and an extent of the second support surface 57 in transverse direction 78 corresponds to an extent of the second clamping surface 61. This results in a distribution of forces resulting from the respective clamping force running as straight as possible and thus as concentrated as possible and on a direct path to the first support surface 56 or to the second support surface 57, where it is dissipated into the support surface.

In this context, it is particularly advantageous if, in any embodiment, the extent in transverse direction 78 of the first support surface 56 or the second support surface 57 corresponds to 0.5 o 1.25 times the extent in transverse direction 78 of the first clamping surface 60 or the second clamping surface 61. By way of example, it can thus be avoided that with a larger extent of the first support surface 56 or the second support surface 57, an unfavorable distribution of forces or stress or deformation curve in the sense of the present invention occurs due to deviations, for example unevenness caused by the manufacturing process, of the respective surfaces. Also, the at least equal extent in transverse direction 78 prevents an impermissibly high stress or deformation from occurring in the first mounting extension 53 or in the second mounting extension 54.

In this case, the first mounting extension 53 and the second mounting extension 54 can be designed such that the ratio of the extension of the first support surface 56 in transverse direction 78 to the extension of the base plate 4 in transverse direction 78 and the ratio of the extension of the second support surface 57 in transverse direction 78 to the extension of the base plate 4 in transverse direction 78 is at most 0.1. This design of the first support surface 56 and the second support surface 57 can further improve the stress decoupling by directing the force flow directly to the first support surface 56 and the second support surface 57, respectively.

Furthermore, the first mounting extension 53 is located in a first outer region 62 of the base plate 4 and the second mounting extension 54 is located in a second outer region 63 of the base plate 4. This arrangement achieves a maximum spacing in transverse direction 78 between the first mounting extension 53 and the second mounting extension 54 as well as a maximum spacing of the first clamping surface 60 and the second clamping surface 71 in transverse direction 78.

As can be seen in particular in the front view shown in FIGS. 3 and 4, the embodiment of the profiled body 2 shown has a recess 64 formed between the upper side 5 and the bottom side 52, which extends in longitudinal direction 77 through the entire base plate 4, forming an upper ridge 66 and a lower ridge 67. By means of the upper ridge 66 and the lower ridge 67, the rigidity is improved compared to a solid design of this area. Mounting recesses 27 may also be provided in the recess 64, spaced apart from one another in the transverse direction 78, in which some of the retaining means 29 engage for attaching the first bearing cover 26 to the first end face 28 or for attaching the second bearing cover 30 to the second end face 32.

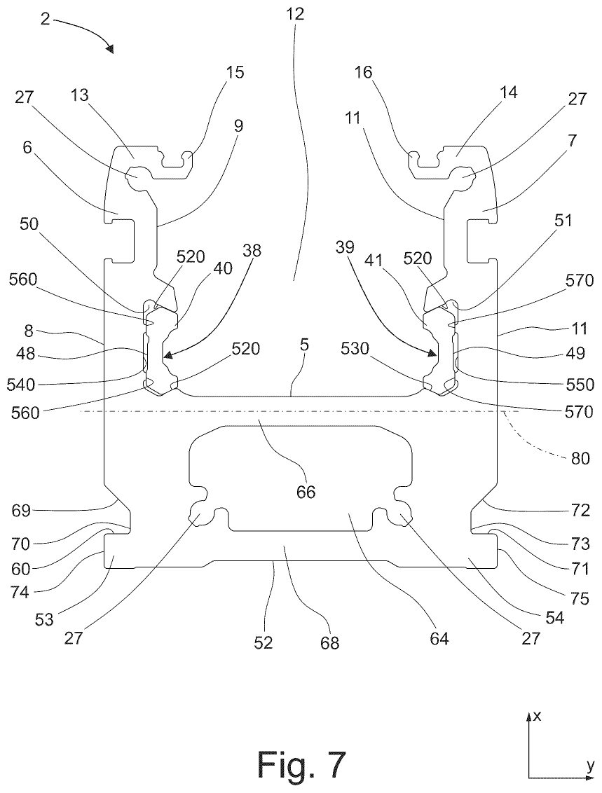

In the first embodiment shown in FIGS. 1 to 5, in the second embodiment shown only as detail B in FIG. 6 and in the third embodiment of the linear guide unit 1 shown in FIG. 7, a distance between a first base plate end face 69 opposite the first clamping surface 60 and the first clamping surface 60 decreases with increasing distance from the first outer side 8 of the profiled body 2. This design results in an angular orientation of the first base plate end face 69 with respect to the first clamping surface 68, whereby in this context one can also speak of a tapered groove, which is formed in the present case by the first clamping surface 61, the first base plate end face 69 and a first connecting surface 70 adjacent to the first clamping surface 61 and to the first base plate end face 69. On the one hand, the angular orientation, which is preferably generated during a first manufacturing process, in particular an extrusion process, enables the stress decoupling to be further improved and, on the other hand, the first clamping surface 61 is more easily accessible for any reworking, in particular machining reworking or selective hardening.

Similarly, a distance between a second base plate end face 72 opposite the second clamping surface 71 and the second clamping surface 71 decreases with increasing distance from the second outer side 10 of the profiled body 2. Again, in the exemplary embodiment shown, the second clamping surface 71 and the second base plate end face 72 are connected by a second connecting surface 73 adjacent to both.

For further stress decoupling, a decoupling groove with an appropriate geometry can be provided in the first connecting surface 70 and/or the second connecting surface 73.

For the most compact possible extension of the profiled body 2 in the transverse direction 78, an outer side 74 of the first mounting extension 53 is oriented parallel to the first outer side 8 of the profiled body 2 and an outer side 75 of the second mounting extension 54 is oriented parallel to the second outer side 11 of the profiled body 2 and the outer side 74 of the first mounting extension 53 and the first outer side 8 and the outer side 75 of the second mounting extension 54 and the second outer side 11 each lie in a common plane.

In an alternative embodiment of the first mounting extension 53 shown in detail B in FIG. 6, a first guiding step 76 adjacent to the first clamping surface 61 is provided on the first mounting extension 53 and projects in the vertical direction 79. In the embodiment shown, the first guiding step 76 is located adjacent to the outer side 73 of the first mounting extension 53, so that the first clamping surface 61 is positioned between the first guiding step 76 and the first connecting surface 70. The second mounting extension 54 can also be designed such that, analogously, a second guiding step adjacent to the second clamping surface 71 and projecting in the vertical direction 79 is provided on the second mounting extension 54. However, it is also conceivable that the first mounting extension 53 and the second mounting extension 54 are designed according to different embodiments.

Preferably, in an alternative embodiment shown in FIG. 7, the recess 64 in the base plate 4 may be positioned or that a ratio of a first distance of a central plane 80 of the upper ridge 66, which extends in the direction of the longitudinal direction 77 and in the direction of the transverse direction 78, to the first support surface 56 or to the second support surface 57 to a second distance of the central plane 80 of the upper ridge 66 to a first upper side 78 of the first leg 6 and/or to a second upper side 79 of the second leg 7 corresponds to the ratio of the second distance to the sum of the first and second distance. As shown by way of example, the first distance corresponds to approximately 38.2% of a total extension of the profiled body 2, which results from the sum of the first distance and the second distance. Accordingly, the central plane 80 of the upper ridge 66 is located in the golden ratio, which results in a particularly favorable distribution of the deformation. Furthermore, a sufficiently large distance between the upper ridge 66 and the lower ridge 67 offers the advantage that, if the transmission element is designed as a belt of a belt transmission, a load strand extends through the receiving space 12 and an idle strand extends through the recess 64. A first and second bearing cover, a coupling element, and a movement-receiving element of this alternative embodiment of a transmission unit or carriage not shown are designed according to the requirements of the belt drive.

1. A linear guide unit comprising:
a profiled body, wherein the profiled body has a base plate with a longitudinal direction, a transverse direction perpendicular thereto and a vertical direction orthogonal to the longitudinal direction and transverse direction,
wherein a first leg and a second leg project from an upper side of the base plate in the vertical direction and are spaced apart from one another in the transverse direction, wherein the profiled body has a first inner side and a first outer side and a second inner side and a second outer side, wherein the first inner side and the second inner side face each other, wherein a first guiding surface is provided on the first inner side and a second guiding surface is provided on the second inner side, and wherein the base plate has a bottom side opposite the upper side, and
a movement unit comprising a carriage which has a guiding unit with a first guiding module arranged on the carriage and a second guiding module arranged opposite the first guiding module at a distance in the transverse direction on the carriage, wherein the movement unit is mounted on the profiled body so as to be linearly movable in the longitudinal direction, in that the first guiding module abutting movably against the first guiding surface and the second guiding module abutting movably against the second guiding surface,
wherein a first mounting extension and a second mounting extension project from the bottom side and are spaced apart from one another in the transverse direction, wherein a first support surface of the first mounting extension and a second support surface of the second mounting extension lie in a common plane and project from the bottom side in the opposite direction to the vertical direction, wherein a first clamping surface opposite the first support surface is provided on the first mounting extension and a second clamping surface opposite the second support surface is provided on the second mounting extension, and wherein the first support surface completely overlaps the first clamping surface and the second support surface completely overlaps the second clamping surface in the transverse direction.

2. The linear guide unit according to claim 1, wherein the extent of the first support surface in the transverse direction corresponds to 0.5 to 1.25 times the extent in the transverse direction of the first clamping surface and/or the second support surface in the transverse direction corresponds to 0.5 to 1.25 times the extent in the transverse direction of the second clamping surface.

3. The linear guide unit according to claim 1, wherein the ratio of the extent of the first support surface in the transverse direction to the extent of the base plate in the transverse direction and the ratio of the extent of the second support surface in the transverse direction to the extent of the base plate in the transverse direction is at most 0.1.

4. The linear guide unit according to claim 1, wherein the extent of the first support surface in the transverse direction corresponds to the extent of the first clamping surface and the extent of the second support surface in the transverse direction corresponds to the extent of the second clamping surface.

5. The linear guide unit according to claim 1, wherein the first clamping surface is oriented parallel to the first support surface and the second clamping surface is oriented parallel to the second support surface.

6. The linear guide unit according to claim 1, wherein the first mounting extension is located in a first outer region of the base plate and the second mounting extension is located in a second outer region of the base plate.

7. The linear guide unit according to claim 1, wherein an upper ridge and a lower ridge are formed by a recess formed between the upper side and the bottom side and which extends in longitudinal direction through the entire base plate.

8. The linear guide unit according to claim 1, wherein a ratio of a first distance of a central plane of the upper ridge to the first support surface and/or to the second support surface to a second distance of the central plane of the upper ridge to a first upper side of the first leg and/or to a second upper side of the second leg corresponds to the ratio of the second distance to the sum of the first and second distance.

9. The linear guide unit according to claim 1, wherein a distance between a first base plate end face opposite the first clamping surface decreases with increasing distance from the first outer side of the profiled body and a distance between a second base plate end face opposite the second clamping surface decreases with increasing distance from the second outer side of the profiled body.

10. The linear guide unit according to claim 1, wherein a first guiding step adjacent to the first clamping surface is provided on the first mounting extension and a second guiding step adjacent to the second clamping surface is provided on the second mounting extension, the first guiding step and the second guiding step projecting in the vertical direction.

11. The linear guide unit according to claim 1, wherein an outer side of the first mounting extension is oriented parallel to the first outer side of the profiled body and an outer side of the second mounting extension is oriented parallel to the second outer side of the profiled body, wherein the outer side of the first mounting extension and the first outer side of the profiled body lie in a common plane and the outer side of the second mounting extension and the second outer side of the profiled body lie in a common plane.

12. The linear guide unit according to claim 1, wherein the first guiding surface is formed on a first guide rail and the second guiding surface is formed on a second guide rail, the first guide rail being force-locked and/or material-locked connected to the first inner side and the second guide rail being force-locked and/or material-locked connected to the second inner side.
